(19) United States
(12) Patent Application Publication
(10) Pub. No.: US 2003/0007043 A1
(43) Pub. Date: Jan. 9, 2003

(54) Ink cartridge and assembling method of atmospheric open valve in ink cartridge

(75) Inventors: Mutsuhiko Ota, Nagano (JP); Yukiharu Suda, Nagano (JP); Hisashi Koike, Nagano (JP); Satoshi Shinada, Nagano (JP); Michinari Tsukahara, Nagano (JP); Hisashi Miyazawa, Nagano (JP)

Correspondence Address: SUGHRUE MION, PLLC, 2100 Pennsylvania Avenue, NW, Washington, DC, 20037-3213, US

(73) Assignee: SEIKO EPSON CORPORATION

(21) Appl. No.: 10/147,325

(22) Filed: May 17, 2002

(30) Foreign Application Priority Data
May 17, 2001 (JP) P2001-147418
Jul. 19, 2001 (JP) P2001-220340
Jul. 19, 2001 (JP) P2001-220354
Aug. 30, 2001 (JP) P2001-262038
Aug. 31, 2001 (JP) P2001-264179

(51) Int. Cl. B41J 2/175

(52) U.S. Cl. 347/86

(57) ABSTRACT

An ink cartridge has a container main body 2 having a through hole 60 for making an ink storage chamber and an atmospheric open chamber 501 to communicate with each other, and an atmospheric open valve 601 having a valve body 65 capable of opening and closing the through hole 60 of the container main body 2 and an elastic member 62 capable of pressing the valve body 65 in a closed direction. In an assembling structure of the atmospheric open valve 601 in the atmospheric open chamber 501, the valve body 65 is placed at such a position blocking the opening of the through hole 60, the elastic member 62 is positioned in the atmospheric open chamber 501 as a bend piece shaped like<is expanded, and the elastic member 62 in the positioned state presses at one end part the valve body 65 in the closed direction and is fixed at an opposite end part to the inside of the atmospheric open chamber 501.

### BACKGROUND OF THE INVENTION

This invention relates to an ink cartridge for supplying ink to a head of a record apparatus, and an assembling method of an atmospheric open valve in the ink cartridge.

An ink jet record apparatus generally comprises a record head mounted on a carriage and moving in the width direction of record paper, and paper feed means for moving the record paper relatively in a direction orthogonal to the move direction of the record head.

Such an ink jet record apparatus prints on record paper by ejecting ink droplets from a record head based on print data.

A record head capable of ejecting black ink, yellow ink, cyan ink, and magenta ink, for example, is mounted on a carriage and in addition to text print in black ink, full-color print is made possible by changing the ink ejection percentage.

Thus, ink cartridges for supplying black ink, yellow ink, cyan ink, and magenta ink to the record head are placed in the main unit of the apparatus.

In the ordinary ink jet record apparatus, the ink cartridges for supplying black ink, yellow ink, cyan ink, and magenta ink are mounted on a carriage and are moved together with the carriage.

In the recent record apparatus, the carriage has been moved at high speed for the purpose of increasing the record speed.

In such a record apparatus, pressure fluctuation occurs in internal ink as an ink supply tube is extended and bent with acceleration and deceleration of the carriage, making unstable ejecting of ink droplets from the record head.

Thus, such an ink cartridge is proposed, that comprises a lower ink storage chamber (ink tank chamber) opened to the atmosphere side, an upper ink storage chamber (ink end chamber) for head connection, connected via an ink flow passage to the lower ink storage chamber, and a differential pressure regulating valve placed at midpoint in a passage connecting the upper ink storage chamber and a head supply port.

According to the ink cartridge, a negative pressure is generated on the head side by negative pressure generation means and the differential pressure regulating valve is opened accordingly for supplying ink to the record head, so that the adverse effect on ink produced by pressure fluctuation mentioned above is lessened and ink can be supplied to the record head at the optimum water head difference.

Such an ink cartridge comprises an atmospheric open valve constructed by: a valve body capable of opening and closing an atmospheric communication hole to make an ink storage chamber and an atmospheric open chamber communicate with each other; and an elastic member capable of pressing the valve body in a closed direction.

As the ink cartridge is mounted to a record apparatus, the atmospheric open valve is opened, whereby the ink storage chamber is made to communicate with the atmospheric side, and on the other hand, as the ink cartridge is detached, the atmospheric open valves is closed, whereby communication between the ink storage chamber and the atmospheric side is shut off.

However, in the assembling structure of the atmospheric open valve in this kind of ink cartridge, the valve body is urged simply by fixing one end part of the elastic member to the inside of the atmospheric open chamber. Therefore, in designing the ink cartridge, the fixing position of the elastic member, etc., needs to be sufficiently considered for determining the urging force of the elastic member. Consequently, the number of design items increases, and design of the ink cartridge is complicated; this is a problem.

It is therefore an object of the invention to provide an ink cartridge and an assembling structure and method of an atmospheric open valve in the ink cartridge, which make it possible to decrease the number of design items and therefore simplify the ink cartridge design.

### SUMMARY OF THE INVENTION

To the end, according to the invention, there is provided an ink cartridge comprising a cartridge main body having an atmospheric communication hole for communicating an ink storage chamber and an atmospheric open chamber with each other; and an atmospheric open valve having a valve body capable of opening and closing the atmospheric communication hole of the cartridge main body, and an elastic member made of a bent piece, preferably shaped like “<”, and capable of pressing the valve body in a closed direction, wherein the elastic member presses at one end part the valve body in the closed direction and is fixed at an opposite end part to the inside of the atmospheric open chamber.

According to the invention, there is provided an ink cartridge comprising a cartridge main body having an atmospheric communication hole for communicating an ink storage chamber and an atmospheric open chamber with each other; and an atmospheric open valve having a valve body capable of opening and closing the atmospheric communication hole of the cartridge main body, and an elastic-member made of a bent piece, preferably shaped like “<”, and capable of pressing the valve body in a closed direction, wherein the valve body is placed at such a position as to close an opening of the atmospheric communication hole, the elastic member is developed and positioned in the atmospheric open chamber, and in the positioned state, the elastic member presses at one end part the valve body in the closed direction and is fixed at an opposite end part to the inside of the atmospheric open chamber.

Because of such a structure, at the time when the atmospheric open valve is assembled, the force urging the valve body by the elastic member is determined.

Therefore, the need for considering the fixing position of the elastic member, etc., at the design time as in the related art is eliminated, so that the number of design items can be decreased and the ink cartridge design can be simplified.

It is desirable that the chamber wall of the atmospheric open chamber is formed with two convex parts projecting in a direction parallel to the axial direction of the atmospheric communication hole, that the convex parts are inserted into the elastic member, that the movement of the one end part of the elastic member is regulated by the insertion end part close to the valve body, and that the insertion end part distant from the valve body is crushed to fix the opposite end part of the elastic member.

Since the ink cartridge is thud configured, the atmospheric open valve is assembled by closing the atmospheric communication hole by the valve body and then inserting the two convex parts into the elastic member, and crushing the insertion end part distant from the valve body for fixing the elastic member.

It is desirable that the crush position of the insertion end part is such a position lessening the spring effective length of the elastic member.

Since the ink cartridge is thus configured, the spring force of the elastic member is enlarged and the force sealing the atmospheric communication hole by the valve body is increased.

On the other hand, according to the invention, there is provided, the assembling method applicable to an ink cartridge comprising a cartridge main body having an atmospheric communication hole for communicating an ink storage chamber and an atmospheric open chamber with each other; and an atmospheric open valve having a valve body capable of opening and closing the atmospheric communication hole of the cartridge main body and an elastic member made of a bent piece, preferably shaped like “<”, and capable of pressing the valve body in a closed direction. The assembling method is an assembling method of the atmospheric open valve in the atmospheric open chamber, and comprises the steps of, to assemble the atmospheric open valve, placing the valve body at such a position as to close an opening of the atmospheric communication hole; developing the elastic member with the valve body pressed in the closed direction, thereby positioning the elastic member in the atmospheric open chamber; and then fixing an end part of the elastic member, opposite from the pressing end part of the elastic member, to the inside of the atmospheric open chamber.

According to such a method, when the atmospheric open valve is assembled, the force urging the valve body by the elastic member is determined.

Therefore, the need for considering the fixing position of the elastic member, etc., at the design time as in the related art is eliminated, so that the number of design items can be decreased and an ink cartridge easily designed can be provided.

It is desirable that to fix the elastic member, a convex part formed on a chamber wall of the atmospheric open chamber and preliminarily inserted into the elastic member is partially crushed under pressure and at room temperature.

According to such a method, the crush force is given to the convex part, and therefore the elastic member can be fixed to the inside of the atmospheric open chamber without deformation of the elastic member.

Further, it is desirable that the crest of the bent part or the proximity thereof is depressed to develop the elastic member.

According to such a method, the seal force for pressing the atmospheric open valve is increased.

Here, it is desirable that while the depressing force of the elastic member is measured, the crest of the bent part or the proximity thereof is depressed and/or that the crest of the bent part or the proximity thereof is depressed until the elastic member is made horizontal.

The present disclosure relates to the subject matter contained in Japanese patent application Nos. 2001-147418 (filed on May 17, 2001), 2001-262038 (filed on Aug. 30, 2001), 2001-264179 (filed on Aug. 31, 2001), 2001-220340 (filed on Jul. 19, 2001), and 2001-220354 (filed on Jul. 19, 2001), which are expressly incorporated herein by reference in their entireties.

### BRIEF DESCRIPTION OF THE DRAWINGS

In the accompanying drawings:

FIG. 1 is an exploded perspective view to show the whole of the ink cartridge according to an embodiment of the invention;

FIGS. 2 (a) and 2 (b) are perspective views to show the appearance of the ink cartridge according to the embodiment of the invention;

FIG. 3 is a perspective view showing the internal structure of the ink cartridge according to the embodiment of the invention as viewed from upward in a slanting direction;

FIG. 4 is a perspective view showing the internal structure of the ink cartridge according to the embodiment of the invention as viewed from downward in a slanting direction;

FIG. 5 is a front view to show the internal structure of the ink cartridge according to the embodiment of the invention;

FIG. 6 is a rear view to show the internal structure of the ink cartridge according to the embodiment of the invention;

FIG. 7 is an enlarged sectional view to show a negative pressure generation system storage chamber of the ink cartridge according to the embodiment of the invention;

FIG. 8 is an enlarged sectional view to show a valve storage chamber of the ink cartridge according to the embodiment of the invention;

FIG. 9 is a front view to show the connection state of the ink cartridge according to the embodiment of the invention to a cartridge holder; and

FIGS. 10 (a) and 10 (b) are a plan view and a sectional view to describe the assembling structure (method) of an atmospheric open valve in the ink cartridge according to the embodiment of the invention.

### DESCRIPTION OF THE PREFERRED EMBODIMENT

Referring now to the accompanying drawings, there are shown preferred embodiments of an ink cartridge and assembling structure and method of an atmospheric open valve in the ink cartridge incorporating the invention.

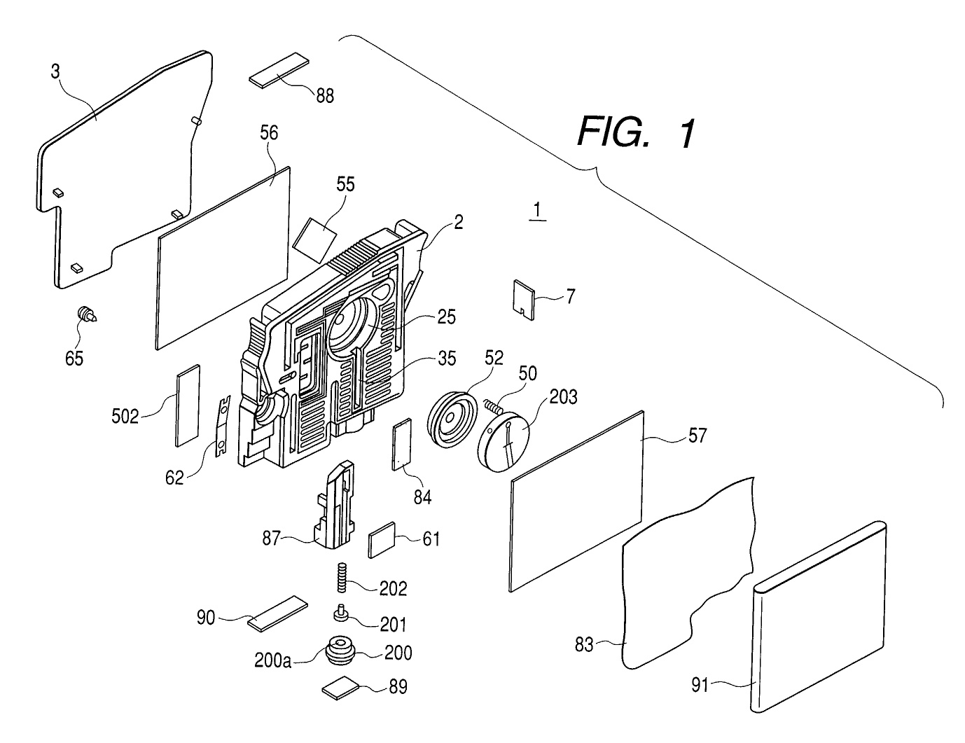

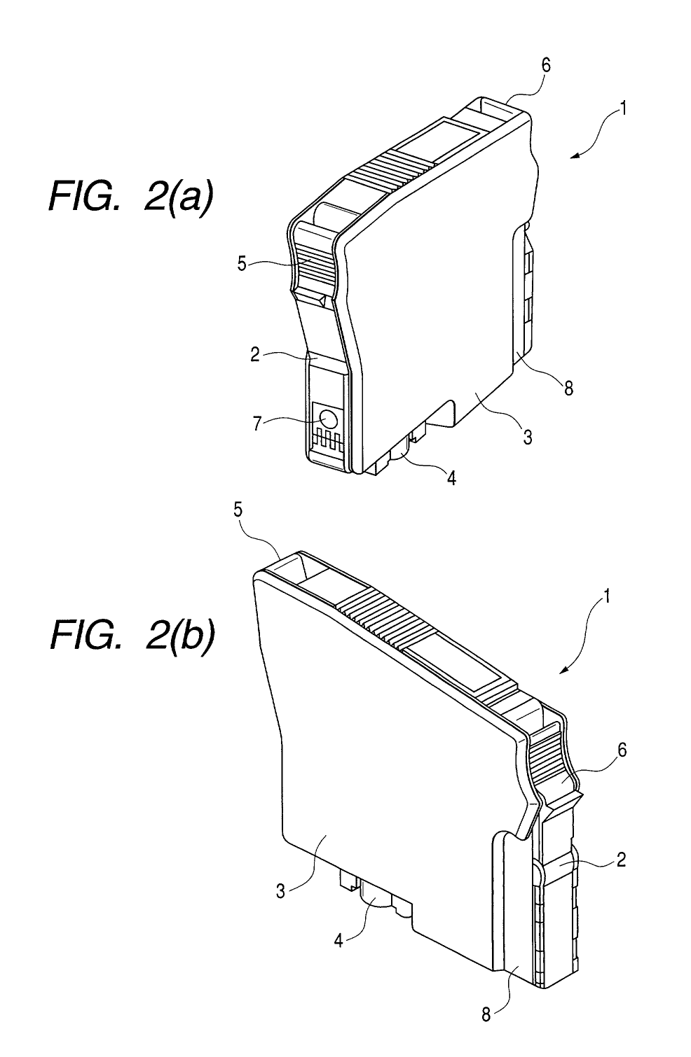

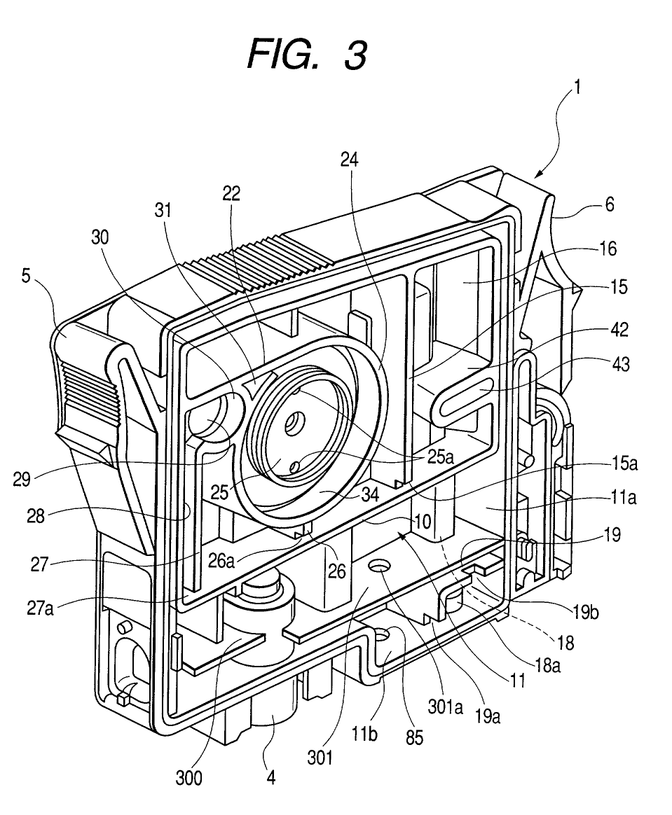

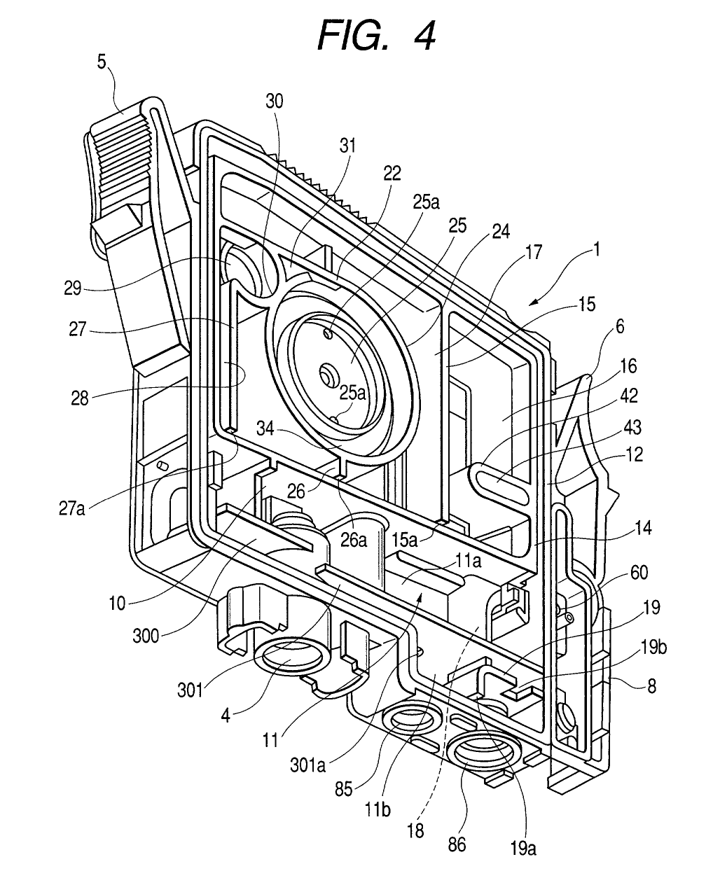

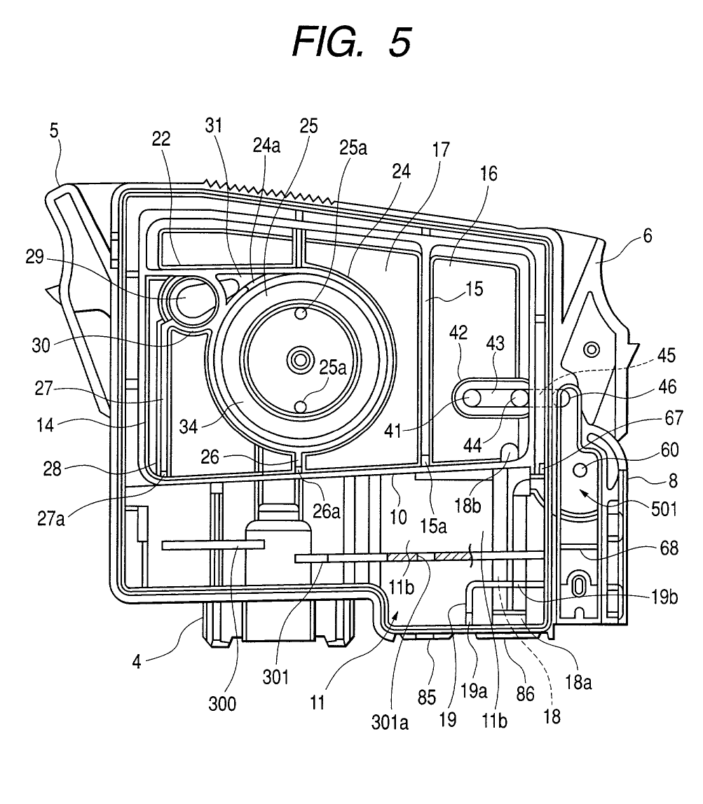

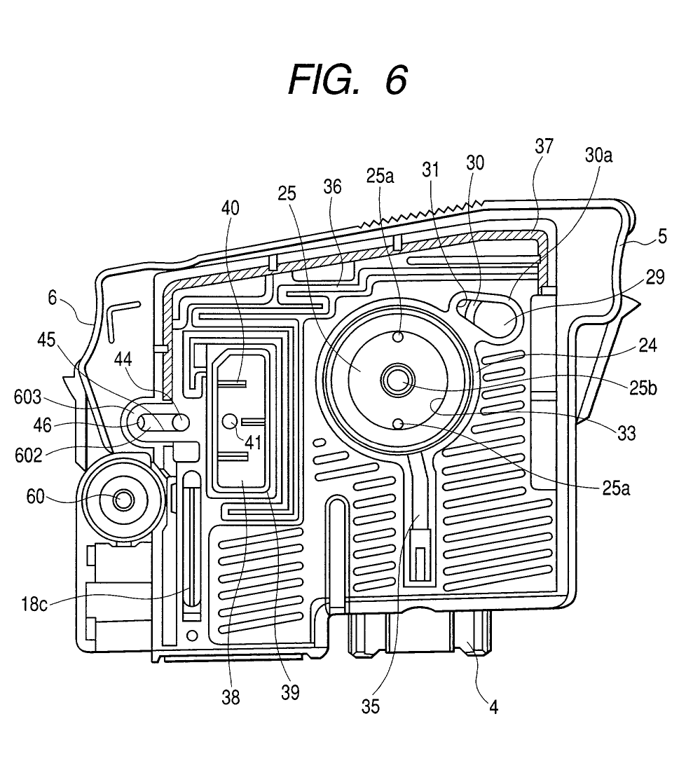

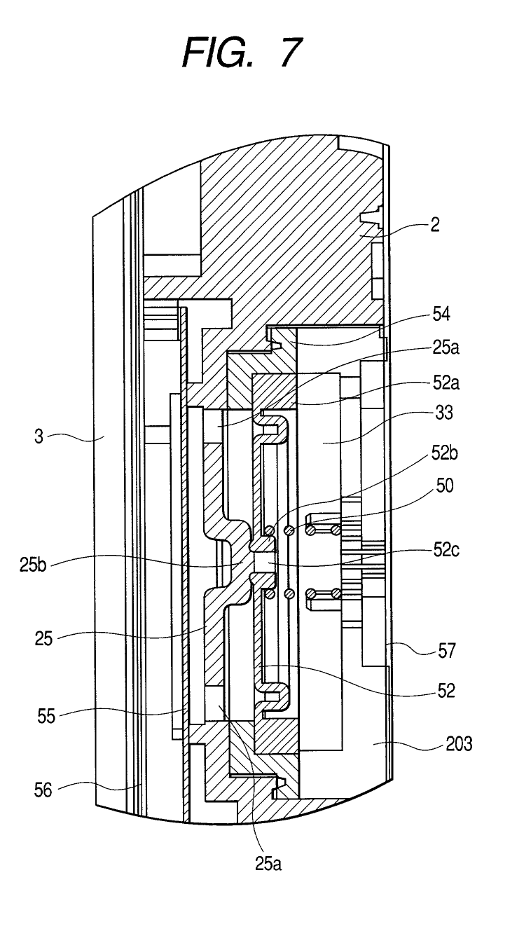

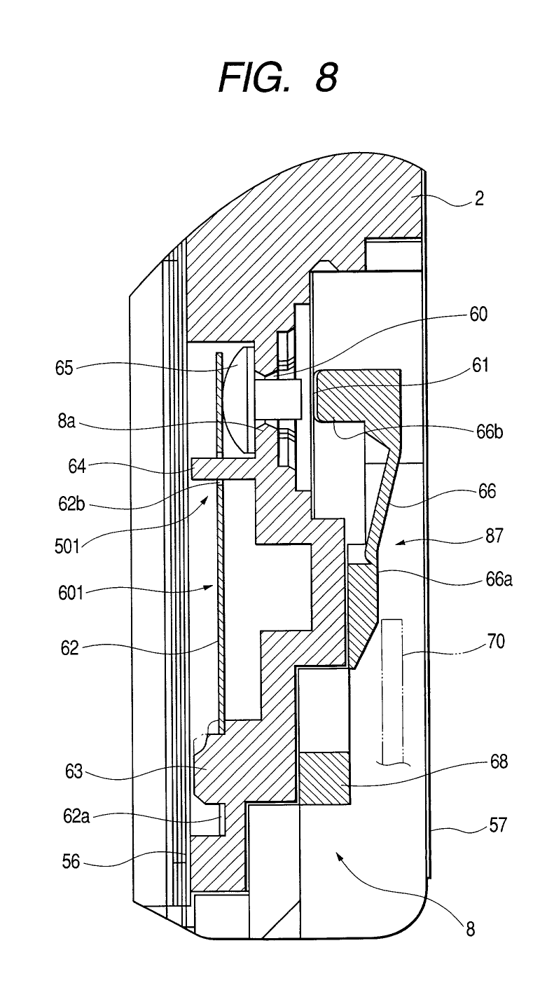

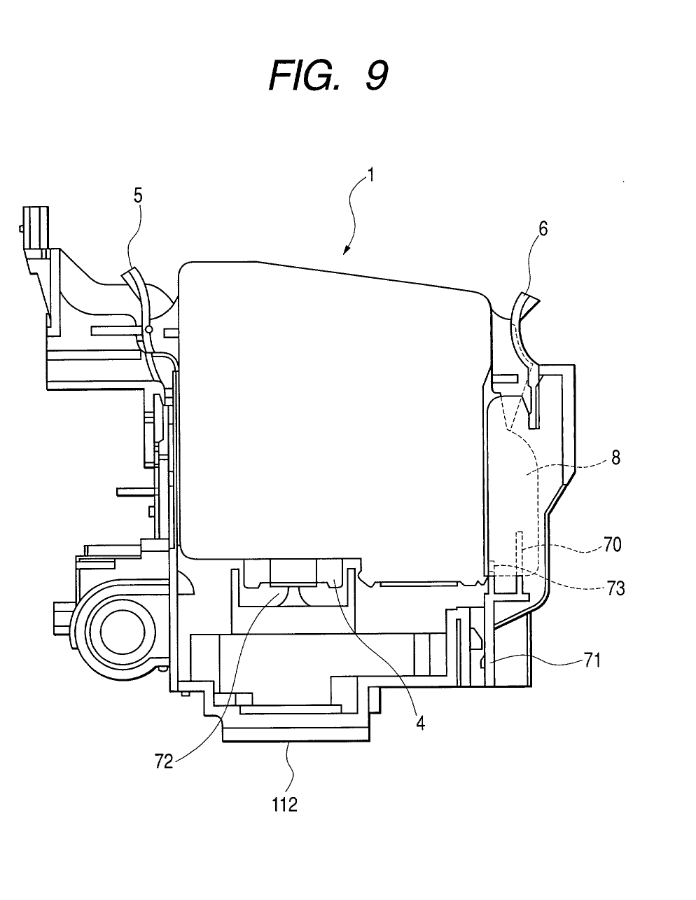

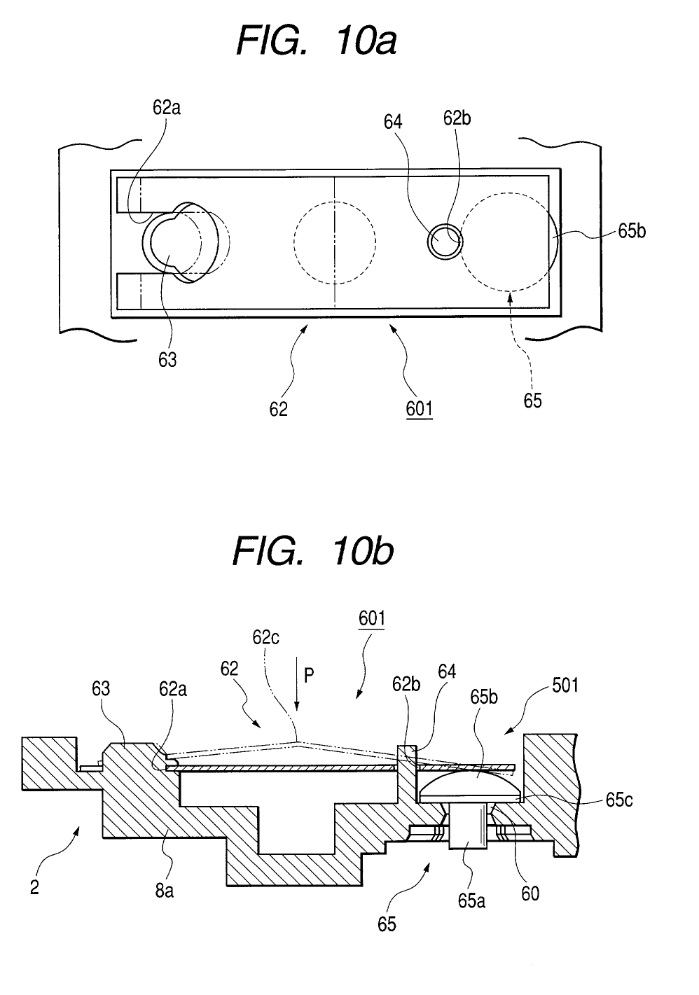

To begin with, the ink cartridge and the assembling structure of the atmospheric open valve will be discussed with reference to FIGS. 1 to 10. FIG. 1 is an exploded perspective view to show the whole of the ink cartridge according to the embodiment of the invention. FIGS. 2 (a) and 2 (b) are perspective views to show the appearance of the ink cartridge according to the embodiment of the invention. FIGS. 3 and 4 are perspective views showing the internal structure of the ink cartridge according to the embodiment of the invention as viewed from upward and downward in a slanting direction. FIGS. 5 and 6 are a front view and a rear view to show the internal structure of the ink cartridge according to the embodiment of the invention. FIGS. 7 and 8 are enlarged sectional views to show a negative pressure generation system storage chamber and a valve storage chamber (assembling structure of atmospheric open valve) of the ink cartridge according to the embodiment of the invention. FIG. 9 is a front view to show the connection state of the ink cartridge according to the embodiment of the invention to a cartridge holder. FIGS. 10 (a) and 10 (b) are a plan view and a sectional view to describe the assembling structure of the atmospheric open valve in the ink cartridge according to the embodiment of the invention.

An ink cartridge 1 shown in FIGS. 2 (a) and 2 (b) has a container main body (lower case) 2 almost rectangular in a plane view, and opened to one side, and a lid body (upper case) 3 for sealing the opening of the container main body 2. The interior of the ink cartridge 1 is generally constructed to have an ink flow passage system and an air flow passage system (both described later).

Formed in the lower portion of the container main body 2 are an ink supply port 4 that can be connected to an ink supply needle 72 of a record head 112 (both are shown in FIG. 9), and a first opening (open hole) 85 and a second opening 86 (both are shown in FIGS. 4 and 5) placed side by side adjacent to the ink supply port 4. The ink supply port 4 is made to communicate with an ink end chamber (differential pressure regulating valve storage chamber) described later, and the first opening 85 is made to communicate with a first ink storage chamber (ink tank chamber) 11.

A substantially cylindrical seal member 200 made of rubber, etc., is placed in the ink supply port 4, as shown in FIG. 1. A through hole 200a axially opened is made at the center of the seal member 200. A spring bracket (valve body) 201 for opening and closing the through hole 200a as the ink supply needle 72 is inserted and removed is disposed in the ink supply port 4, and further a helical compression spring 202 for urging the spring bracket 201 to the seal member 200 is placed.

The second opening 86 is made to communicate with the first ink storage chamber 11 through an atmospheric communication port 86a, and communicate with the ink end chamber (second ink storage chamber 16, third ink storage chamber 17, etc.,) through an ink injection port 86b, as shown in FIGS. 10 (a) and 10 (b).

Retention members 5 and 6 that can be attached to and detached from a cartridge holder are provided integrally on the upper sides of the container main body 2. A circuit board (IC board) 7 is disposed below one retention member 5 as shown in FIG. 2 (a), and a valve storage chamber 8 is disposed below the other retention member 6 as shown in FIGS. 2 (a) and 2 (b).

The circuit board 7 has a storage device retaining information data concerning ink, for example, color type, pigment/dye based ink type, ink remaining amount, serial number, expiration date, applied model, and the like so that the data can be written.

The valve storage chamber 8 has an internal space opened to the cartridge insertion side (lower side) as shown in FIG. 8, and an identification piece(s) 73 and a valve operation rod 70 (shown in FIG. 9) on the record apparatus matching with the ink cartridge 1 advance and retreat in the internal space. An operation arm 66 of an identification block 87, which is rotated as the valve operation rod 70 advances and retreats, is housed in the upper part of the internal space. An identification convex part(s) 68 for determining whether or not the ink cartridge matches with a given record apparatus is formed in the lower part of the internal space. The identification convex part 68 is placed at a position for making possible a determination by the valve operation rod 70 (the identification piece 73) of a cartridge holder 71 (shown in FIG. 9) before the ink supply needle 72 (shown in FIG. 9) on the record apparatus is made to communicate with the ink supply port 4 (before an atmospheric open valve described later is opened).

A through hole 60 as an atmospheric communication hole opened and closed by the opening and closing operation of an atmospheric open valve 601 is made in a chamber wall 8a of the valve storage chamber 8 (atmospheric open chamber 501), as shown in FIG. 8. Convex parts 63 and 64 projecting in a direction parallel to the axial direction of the through hole 60 are formed integrally on the chamber wall 8a. The operation arm 66 is placed on one opening side of the through hole 60, and the atmospheric open valve 601 is placed on the other opening side of the through hole 60. The operation arm 66 has an operation part 66b for pressing a pressurization film (elastically deformable film) 61, and is placed projecting in an upward slanting direction into the path of the valve operation rod 70 and is fixed to the container main body 2 through a rotation supporting point 66a.

The pressurization film 61 is attached to the chamber wall 8a so as to block the through hole 60, and the whole of the pressurization film 61 is formed of an elastic seal member of rubber, etc. The internal space formed between the pressurization film 61 and the opening peripheral margin of the through hole 60 is opened to a through hole 67 communicating with the first ink storage chamber (ink tank chamber) 11 (both are shown in FIG. 5).

The atmospheric open valve 601 has a valve body 65 capable of opening and closing the through hole 60, and an elastic member 62 capable of pressing the valve body 65 in a closed direction, as shown in FIGS. 8 and 10 (a) and 10 (b). The valve body 65 has a cylinder part 65a inserted into the through hole 60, and a valve part 65b capable of being pressed into contact with the opening peripheral margin of the through hole 60 in a closed valve state. The whole of the valve body 65 is formed of an elastic material, such as an elastomer, etc. The elastic member 62 has, at its end portions, a notch 62a and a through hole 62b into which the projections (convex parts) 63 and 64 are respectively inserted, and is formed of a plate spring that can be positioned in the atmospheric open chamber 501 as a bend piece (bend part 62c) shaped like “<”, made of stainless steel, etc., for example, is developed. The movement of the end part of the elastic member 62 close to the valve body 65 is regulated by the projection 64, so that the elastic member 62 presses and urges the valve body 65 when the elastic member 62 is positioned in place. The end part distant from the valve body 65 is fixed by crushing (deforming) the insertion end part of the projection 63 (a part of the projection 63). The crushed position on the projection 63 is so selected as to reduce the spring effective length of the elastic member 62 in order to enlarge the spring force (press urging force) of the elastic member 62 and enhance the force sealing the through hole 60 by the valve body 65.

In FIG. 1, numeral 88 denotes an identification label put on an upper face part of the container main body 2 corresponding to the block 87, numeral 89 denotes a film for sealing the ink supply port 4 (through hole 200a), and numeral 90 denotes a film for sealing the first opening 85 and the second opening 86. Numeral 91 denotes a vacuum pack for wrapping the ink cartridge 1 already filled with ink.

Next, the ink flow passage system and the air flow passage system in the container main body 2 will be discussed with reference to FIGS. 1 to 9.

[Ink Flow Passage System]

The ink cartridge 1 is formed with an internal space by joining the lid body 3 to the front of the container main body 2 through inner films (air shield films) 56 and 502 and joining a protective label 83 to the rear of the container main body 2 through an outer film (air shield film) 57, as shown in FIG. 1. The internal space is divided into upper and lower parts by a partition wall 10 extending slightly downward toward the ink supply port side opposed to the record head 112 (shown in FIG. 9), as shown in FIGS. 3 to 5. The lower area of the internal space provides the first ink storage chamber 11 opened to the atmosphere in the connection state to the record head 112.

Two intermediate walls 300 and 301 different in height position are disposed in the first ink storage chamber 11. One intermediate wall 300 is placed with a predetermined spacing from one side surface part of the first ink storage chamber 11. The other intermediate wall 301 is opposed to the bottom part of the first ink storage chamber 11 and is placed on the ink supply port side of the intermediate wall 300. The intermediate wall 301 partitions the first ink storage chamber 11 into two space parts 11a and 11b placed side by side in the ink injection direction (up and down). The intermediate wall 301 is formed with a through part 301a having the same axis as the axis of the first opening 85.

On the other hand, the upper area of the internal space is defined by a frame 14 with the partition wall 10 as a bottom part. The internal space of the frame 14 forms (a part of) the ink end chamber connected to the record head 112, and the front side of the ink end chamber is divided into left and right parts by a vertical wall 15 having a communication port 15a. One of the areas into which the internal space is divided provides a second ink storage chamber 16, and the other area provides a third ink storage chamber 17.

A communication flow passage 18 communicating with the first ink storage chamber 11 is connected to the second ink storage chamber 16. The communication flow passage 18 has communication ports 18a and 18b at lower and upper positions. The communication flow passage 18 is formed by a recess part 18c (shown in FIG. 6) opened to the rear of the container main body 2 and extending in the up and down direction and an air shield film (outer film 57) for blocking and sealing the opening of the recess part 18c. A partition wall 19 having two lower and upper communication ports 19a and 19b communicating with the inside of the first ink storage chamber 11 is provided upstream from the communication flow passage 18. One communication port 19a is placed at a position opened to the lower area in the first ink storage chamber 11. The other communication port 19b is placed at a position opened to the upper area in the first ink storage chamber 11.

On the other hand, the third ink storage chamber 17 is formed with a differential pressure regulating valve storage chamber 33 (shown in FIG. 6) for storing a differential pressure regulating valve 52 (membrane valve) shown in FIG. 7 and a filter chamber 34 (shown in FIG. 5) for storing a filter 55 (nonwoven fabric filter) shown in FIG. 7 by a laterally elongating partition wall 22 and an annular partition wall 24. The partition wall 25 is formed with through holes 25a for introducing ink passed through the filter 55 into the differential pressure regulating valve storage chamber 33 from the filter chamber 34.

The partition wall 24 is formed at a lower part with a partition wall 26 having a communication port 26a between the partition wall 24 and the partition wall 10, and is formed on a side with a partition wall 27 having a communication port 27a between the partition wall 24 and the frame 14. A communication passage 28 communicating with the communication port 27a and extended in the up and down direction is provided between the partition wall 27 and the frame 14. A through hole 29 communicating with the filter chamber 34 through the communication port 24a and an area 31 is placed in an upper part of the communication passage 28.

The through hole 29 is formed by a partition wall (annular wall) 30 continuous to the partition wall 27.

The area 31 is formed by the partition walls 22, 24, and 30 and a partition wall 30a (shown in FIG. 6). The area 31 is formed deep at one end part of the container main body 2 (portion communicating with the through hole 29) and shallow at an opposite end part (portion communicating with the filter chamber 34).

The differential pressure regulating valve storage chamber 33 stores the membrane valve 52 as a differential pressure regulating valve that can become elastically deformed, such as an elastomer, as shown in FIG. 7. The membrane valve 52 has a through hole 52c, and is urged to the filter chamber side by a helical compression spring 50, and has an outer peripheral margin fixed through an annular thick part 52a to the container main body 2 by ultrasonic welding. The helical compression spring 50 is supported at one end part by a spring bracket 52b of the membrane valve 52 and at an opposite end part by a spring bracket 203 in the differential pressure regulating valve storage chamber 33. The position accuracy of the helical compression spring 50 to the membrane valve 52 is an important element for the differential pressure regulating valve to control the differential pressure, and the convex part of the membrane valve 52 needs to be placed by the helical compression spring 50 without bend, position shift, etc., as shown in FIG. 7.

Numeral 54 denotes a frame formed integrally with the thick part 52a of the membrane valve 52.

The filter 55 for allowing ink to pass through and capturing dust, etc., is placed in the filter chamber 34, as shown in FIG. 7. The opening of the filter chamber 34 is sealed with the inner film 56 and the opening of the differential pressure regulating valve storage chamber 33 is sealed with the outer film 57. When the pressure in the ink supply port 4 lowers, the membrane valve 52 is separated from a valve seat part 25b against the urging force of the helical compression spring 50 (the through hole 52c is opened) . Thus, ink passed through the filter 55 passes through the through hole 52c and flows into the ink supply port 4 through the flow passage formed by the recess part 35. When the ink pressure in the ink supply port 4 rises to a predetermined value, the membrane valve 52 sits on the valve seat part 25b by the urging force of the helical compression spring 50, shutting off the flow of ink. Such operation is repeated, whereby ink is supplied to the ink supply port 4 while a constant negative pressure is maintained.

[Air Flow Passage System]

As shown in FIG. 6, the container main body 2 is formed on the rear with a meander groove 36 for raising flow passage resistance, and a wide concave groove 37 (hatched portion) opened to the atmosphere, and further a recess part 38 (space part) having an almost rectangular shape in a plane view leading to the first ink storage chamber 11 (shown in FIG. 5). The recess part 38 contains a frame 39 and ribs 40, onto which an air permeable film 84 is stretched and fixed to thereby form an atmospheric ventilation chamber. A through hole 41 is made in the bottom part (wall part) of the recess part 38 and is made to communicate with an elongated area 43 defined by the partition wall 42 (shown in FIG. 5) of the second ink storage chamber 16. The area 43 has a through hole 44 and is made to communicate with the atmospheric open chamber 501 (shown in FIG. 8) through a communication groove 45 defined by a partition wall 603 and a through hole 46 opened to the communication groove 45. The opening of the atmospheric open chamber 501 is sealed with the inner film (air shield film) 502 shown in FIG. 1.

According to the configuration, when the ink cartridge 1 is mounted to the cartridge holder 71 as shown in FIG. 9, the valve operation rod 70 of the cartridge holder 71 abuts the operation arm 66 shown in FIG. 8 for moving the convex part 66b (pressurization film 61) to the valve body side. Accordingly, the valve body 65 is separated from the opening peripheral margin of the through hole 60 against the elastic urging force of the elastic member 62, while being guided by the convex part 64, and the first ink storage chamber 11 shown in FIG. 5 is opened to the recess part 38 (atmosphere) shown in FIG. 6 through the through holes 67, 60, and 46, the groove 45, the through hole 44, the area 43, the through hole 41, etc. The valve body 201 in the ink supply port 4 is opened by insertion of the ink supply needles 72.

As the valve body 201 in the ink supply port 4 is opened and ink is consumed by the record head 112, the pressure of the ink supply port 4 falls below a stipulated value. Thus, the membrane valve 52 in the differential pressure regulating valve storage chamber 33 shown in FIG. 7 is opened (if the pressure of the ink supply port 4 rises above the stipulated value, the membrane valve 52 is closed), ink in the differential pressure regulating valve storage chamber 33 flows into the record head 112 through the ink supply port 4.

Further, as consumption of ink in the record head 112 proceeds, ink in the first ink storage chamber 11 flows into the second ink storage chamber 16 through the communication flow passage 18 shown in FIG. 4.

On the other hand, as ink is consumed, air flows in through the through hole 67 (shown in FIG. 5) communicating with the atmosphere, and the ink liquid level in the first ink storage chamber 11 lowers. As ink is further consumed and the ink liquid level reaches the communication port 19a, ink from the first ink storage chamber 11 (opened to the atmosphere through the through hole 67 at the ink supplying time) flows into the second ink storage chamber 16 via the communication flow passage 18 together with air. Since bubbles are moved up by a buoyant force, only the ink flows into the third ink storage chamber 17 through the communication port 15a in the lower part of the vertical wall 15, passes through the communication port 26a of the partition wall 26 from the third ink storage chamber 17, moves up on the communication passage 28, and flows into the upper part of the filter chamber 34 from the communication passage 28 through the area 31 and the communication port 24a.

After this, the ink in the filter chamber 34 passes through the filter 55 shown in FIG. 7, flows into the differential pressure regulating valve storage chamber 33 from the through holes 25a, further passes through the through hole 52c of the membrane valve 52 separated from the valve seat part 25b and then moves down in the recess part 35 shown in FIG. 6 and flows into the ink supply port 4.

The ink is thus supplied from the ink cartridge 1 to the record head 112.

If a different kind of ink cartridge 1 is placed in the cartridge holder 71, before the ink supply port 4 arrives at the ink supply needle 72, the identification convex part 68 (shown in FIG. 7) abuts the identification piece 73 (shown in FIG. 9) of the cartridge holder 71, blocking entry of the valve operation rod 70. Therefore, occurrence of trouble as a different kind of ink cartridge is placed can be prevented. In this state, the valve operation rod 70 does not arrive at the operation arm 66 either and thus the valve body 65 is maintained in the closed valve state, preventing evaporation of the ink solvent in the first ink storage chamber 11 as it is left standing.

On the other hand, if the ink cartridge 1 is drawn out from the placement position in the cartridge holder 71, the operation arm 66 is elastically restored because it is no longer supported by the operation rod 70, and the valve body 65 is elastically restored accordingly, blocking the through hole 60, so that communication between the recess part 38 and the first ink storage chamber 11 is shut off.

Next, an assembling method of the atmospheric open valve in the ink cartridge according to the embodiment will be discussed with reference to FIGS. 10 (a) and 10 (b).

To begin with, as shown in FIGS. 10 (a) and 10 (b), the cylinder part 65a is inserted in the through hole 60, and the valve part 65b is brought into contact with the opening peripheral margin of the through hole 60, whereby the valve body 65 is disposed within the atmospheric open chamber 501.

Next, the projection 63 is inserted into the notch 62a of the elastic member 62, and the projection 64 is inserted into the through hole 62b, so that the elastic member 62 in the bent form like “<” is held on the chamber wall 8a of the valve storage chamber 8 (atmospheric open chamber 501) and the valve body 65, as indicated by the two-dotted chain line in FIGS. 10 (a) and 10 (b).

Depressing pressure P is given to the bend part 62c of the elastic member 62 indicated by the two-dotted lines in FIG. 10 (b) to develop the elastic member 62 into the plane state (so as to be made horizontal) while pressing the valve body 65 in the closed direction as shown by the solid line in FIG. 10(b). Under the positioning or the elastic member 62 to the projections 63 and 64 in this fashion, a part of the projection 63 is crushed at room temperature to fix the elastic member 62 within the atmospheric open chamber 501. At this time, if the projection 63 is crushed, while the crest of the bend part 62c is depressed and held, a large elastic force from the elastic member 62 acts on the atmospheric open valve 601, and the force sealing the through hole 60 by the atmospheric open valve 601 can be increased. Preferably, the depressing pressure onto the crest of the bend part 62c is set to be a predetermined depressing pressure (100 g or more) and the crest of the bend part 62c is depressed until the elastic member 62 is made horizontal. In the description made above, the crest of the bend part 62c is depressed, but the proximity of the crest of the bend part 62c (predetermined range) may be depressed.

According to this method, when the atmospheric open valve 601 is assembled, the force urging the valve body 65 by the elastic member 62 is determined.

Therefore, in the embodiment, the need for considering the fixing position of the elastic member, etc., at the design time as in the related art is eliminated, so that the number of design items can be decreased and an ink cartridge 1 easily designed can be obtained.

In the embodiment, in fixing the elastic member 62, the projection 63 is inserted into the notch 62a and a part of the insertion end part is crushed at room temperature. Accordingly, the elastic member 62 can be prevented from becoming deformed.

In addition, as shown, for example, in FIG. 10 (b), the valve body 65 preferably has a sealing part 65c that defines a sealing surface of the valve part 65b opposing the through hole 60 and that is made of relatively soft material (elastic material) such as an elastomer.

As seen in the description made above, according to the ink cartridge and the assembling method of the atmospheric open valve in the ink cartridge according to the invention, the number of design items can be decreased and therefore the ink cartridge design can be simplified.

What is claimed is:

1. An ink cartridge comprising:
a cartridge main body having an atmospheric communication hole for communicating an ink storage chamber and an atmospheric open chamber with each other; and
an atmospheric open valve having a valve body capable of opening and closing the atmospheric communication hole of said cartridge main body, and an elastic member capable of pressing the valve body in a closed direction, wherein:
the elastic member presses, at one end part, the valve body in the closed direction, and is fixed, at an opposite end part, to an inside of the atmospheric open chamber.

2. The ink cartridge according to claim 1, wherein the elastic member is made of a bent piece.

3. The ink cartridge according to claim 1, wherein the valve body includes a valve part contacting the one end part of the elastic member and selectively opening and closing the atmospheric open valve, and a projcting part extending from the valve part and being movably inserted into the atmospheric communication hole.

4. The ink cartridge according to claim 3, wherein the valve part further includes a sealing part that defines a sealing surface of the valve part opposing the atmospheric communication hole and that is made of relatively soft material.

5. An ink cartridge comprising:
a cartridge main body having an atmospheric communication hole for communicating an ink storage chamber and an atmospheric open chamber with each other; and
an atmospheric open valve having a valve body capable of opening and closing the atmospheric communication hole of said cartridge main body, and an elastic member made of a bent piece and capable of pressing the valve body in a closed direction, wherein:
the valve body is disposed at such a position as to close an opening of the atmospheric communication hole;
the elastic member is developed to be positioned in place in the atmospheric open chamber; and
in a state of positioning the elastic member in place, the elastic member presses, at one end part, the valve body in the closed direction, and is fixed, at an opposite end part, to an inside of the atmospheric open chamber.

6. The ink cartridge as claimed in claim 5, wherein:
a chamber wall of the atmospheric open chamber is formed with two convex parts projecting in a direction parallel to an axial direction of the atmospheric communication hole;
the convex parts are inserted into the elastic member;
movement of the one end part of the elastic member is regulated by an inserted end part of the convex part close to the valve body; and
an inserted end part of the convex part distant from the valve body is crushed under pressure to fix the opposite end part of the elastic member.

7. The ink cartridge as claimed in claim 6, wherein a crush position of the inserted end part is selected to reduce a spring effective length of the elastic member.

8. An assembling method for an ink cartridge comprising:
a cartridge main body having an atmospheric communication hole for communicating an ink storage chamber and an atmospheric open chamber with each other; and
an atmospheric open valve having a valve body capable of opening and closing the atmospheric communication hole of the cartridge main body, and an elastic member made of a bent piece and capable of pressing the valve body in a closed direction,
wherein the method of assembling the atmospheric open valve in the atmospheric open chamber comprises the steps of:
placing the valve body at such a position as to close an opening of the atmospheric communication hole;
then, developing the elastic member with the valve body pressed in the closed direction, thereby positioning the elastic member in place in the atmospheric open chamber; and
thereafter, fixing an end part of the elastic member, opposite from a pressing end part of the elastic member, onto an inside of the atmospheric open chamber.

9. The assembling method of the atmospheric open valve as claimed in claim 8, wherein in fixing the elastic member, a convex part formed on a chamber wall of the atmospheric open chamber and preliminarily inserted into the elastic member is partially crushed under pressure and at room temperature.

10. The assembling method of the atmospheric open valve as claimed in claim 8 or 9, wherein a crest of the bent part or a proximity thereof is depressed to develop the elastic member.

11. The assembling method of the atmospheric open valve as claimed in claim 10, wherein while a depressing force onto the elastic member is measured, the crest of the bent part or the proximity thereof is depressed to develop the elastic member.

12. The assembling method of the atmospheric open valve as claimed in claim 10 or 11, wherein the crest of the bent part or the proximity thereof is depressed so that the elastic member is made horizontal.
